(19) United States
(12) Patent Application Publication
(10) Pub. No.: US 2024/0357087 A1
(43) Pub. Date: Oct. 24, 2024

(54) METHOD AND APPARATUS FOR VIDEO CODING USING IMPROVED AMVP-MERGE MODE

(71) Applicants: HYUNDAI MOTOR COMPANY, Seoul (KR); KIA CORPORATION, Seoul (KR)

(72) Inventors: Jin Heo, Yongin-si (KR); Seung Wook Park, Yongin-si (KR)

(73) Assignees: HYUNDAI MOTOR COMPANY, Seoul (KR); KIA CORPORATION, Seoul (KR)

(21) Appl. No.: 18/762,357

(22) Filed: Jul. 2, 2024

Related U.S. Application Data
(63) Continuation of application No. PCT/KR2022/020477, filed on Dec. 15, 2022.

(30) Foreign Application Priority Data
Jan. 5, 2022 (KR) 10-2022-0001438
Dec. 14, 2022 (KR) 10-2022-0175117

(51) Int. Cl. H04N 19/105; H04N 19/176

(52) U.S. Cl. CPC H04N 19/105; H04N 19/176

(57) ABSTRACT

A method and an apparatus are disclosed for video coding using an improved AMVP-MERGE mode. The video coding method and the apparatus use an improved AMVP-MERGE mode, which is a combined inter-prediction mode of advanced motion vector prediction (AMVP) mode and merge mode. The video coding method and the apparatus determine a merge index in the improved AMVP-MERGE mode according to a rate-distortion optimization (RDO) in place of template matching or bilateral matching.

### CROSS-REFERENCE TO RELATED APPLICATIONS

This application is a continuation of International Application No. PCT/KR2022/020477 filed on Dec. 15, 2022, which claims priority to and the benefit of Korean Patent Application No. 10-2022-0001438 filed on Jan. 5, 2022, and Korean Patent Application No. 10-2022-0175117, filed on Dec. 14, 2022, the entire contents of each of which are incorporated herein by reference.

### TECHNICAL FIELD

The present disclosure relates to a video coding method and an apparatus using an improved combined inter-prediction mode of advanced motion vector prediction mode and merge mode (AMVP-MERGE mode).

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

AMVP-MERGE mode is a combined inter-prediction mode of advanced motion vector prediction mode (AMVP mode) and merge mode. AMVP-MERGE mode generates one-directional prediction block by using the AMVP-mode prediction method and generates the other-directional prediction block by using the merge-mode prediction method. The two prediction blocks are then combined to generate a prediction block of the AMVP-MERGE mode.

To generate the AMVP prediction block in AMVP-MERGE mode, the reference index and motion vector difference (MVD) are transmitted/parsed as in the regular uni-directional AMVP mode. The motion vector predictor (MVP) index is not transmitted/parsed if template matching is enabled, or transmitted/parsed if template matching is not enabled. The MVP index may be derived by using an AMVP candidate list. Meanwhile, to generate a merge predictor block, a merge index is derived without being transmitted/parsed, by using template matching (TM) or bilateral matching (BM). The merge index may be derived by using a merging candidate list. The AMVP-MERGE mode uses the AMVP and merge modes' template matching (TM) or bilateral matching (BM) to generate the cost of the prediction block and then determines merge index information based on the generated cost.

The AMVP-MERGE mode is susceptible to low accuracy of such information determined according to the cost of generating the prediction block. In addition, the AMVP-MERGE mode causes the encoder to select the merge index information, which is supposed to be derived by the decoder performing the template matching (TM) or bilateral matching (BM). This increases the complexity of the decoder. Therefore, to increase the video coding efficiency and enhance the video quality, the AMVP-MERGE mode needs to be improved.

### SUMMARY

The present disclosure seeks to provide a video coding method and an apparatus using an improved combined inter-prediction mode of advanced motion vector prediction mode and merge mode (AMVP-MERGE mode) to enhance video quality and increase video coding efficiency. The video coding method and the apparatus determine a merge index in the improved AMVP-MERGE mode according to a rate-distortion optimization (RDO) in place of template matching or bilateral matching.

At least one aspect of the present disclosure provides a method performed by a video decoding device for generating a prediction block of a current block. The method includes generating a prediction block in an advanced motion vector prediction mode (AMVP mode) in an AMVP-MERGE mode. The method also includes decoding, for a merge mode in the AMVP-MERGE mode, a merge index of the merge mode from a bitstream. The method also includes generating a merging candidate list of the merge mode. The method also includes deriving, by using the merge index, a reference picture in the merge mode and a motion vector from the merging candidate list. The method also includes generating a prediction block in the merge mode by using the reference picture in the merge mode and the motion vector. The method also includes combining the prediction block in the AMVP mode with the prediction block in the merge mode to generate a prediction block of the current block.

Another aspect of the present disclosure provides a method of decoding a motion vector of a current block by a video decoding device. The method includes generating a prediction block in an advanced motion vector prediction mode (AMVP mode) in an AMVP-MERGE mode. The method also includes generating, for a merge mode in the AMVP-MERGE mode, a merging candidate list of the merge mode. The method also includes generating a prediction block in the merge mode by using the merging candidate list. The method also includes combining the prediction block in the AMVP mode with the prediction block in the merge mode to generate a prediction block of the current block. The method also includes determining a merge index of the merge mode.

Yet another aspect of the present disclosure provides a computer-readable recording medium storing a bitstream generated by a video encoding method. The video encoding method includes generating a prediction block in an advanced motion vector prediction mode (AMVP mode) in an AMVP-MERGE mode. The video encoding method also includes generating, for a merge mode in the AMVP-MERGE mode, a merging candidate list of the merge mode. The video encoding method also includes generating a prediction block in the merge mode by using the merging candidate list. The video encoding method also includes combining the prediction block in the AMVP mode with the prediction block in the merge mode to generate a prediction block of a current block. The video encoding method also includes determining a merge index of the merge mode.

As described above, the present disclosure provides a video coding method and an apparatus using an improved AMVP-MERGE mode, which is a combined inter-prediction mode of AMVP mode and merge mode. The video coding method and the apparatus determine a merge index in the improved AMVP-MERGE mode according to a rate-distortion optimization in place of template matching or bilateral matching. Thus, the video coding method and the apparatus improve video quality and increase video coding efficiency.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a diagram illustrating template matching.

FIG. 7 is a diagram illustrating a block selected in an advanced motion vector prediction (AMVP) mode and merge candidates in a merging candidate list.

FIG. 8 is a diagram illustrating an existing merging candidate list and a merging candidate list for a combined inter-prediction mode of advanced motion vector prediction mode and merge mode (AMVP-MERGE mode).

FIG. 9 is a flowchart of a method performed by a video encoding device for generating a prediction block according to an improved AMVP-MERGE mode, in at least one embodiment of the present disclosure.

FIG. 10 is a flowchart of a method performed by a video decoding device for generating a prediction block according to the improved AMVP-MERGE mode, in at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

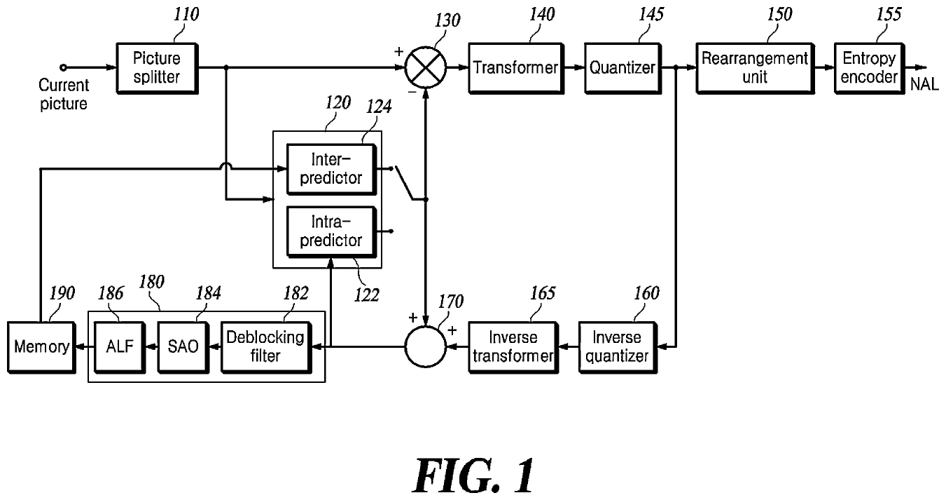

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component. One video is constituted by one or more sequences including a plurality of pictures.

Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

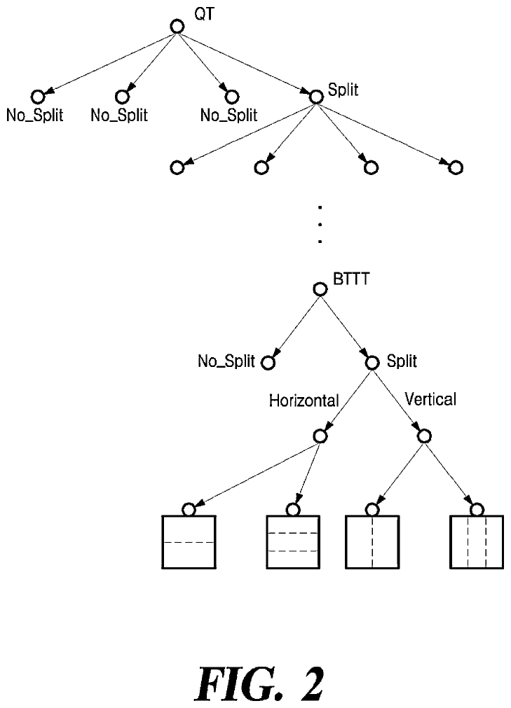

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

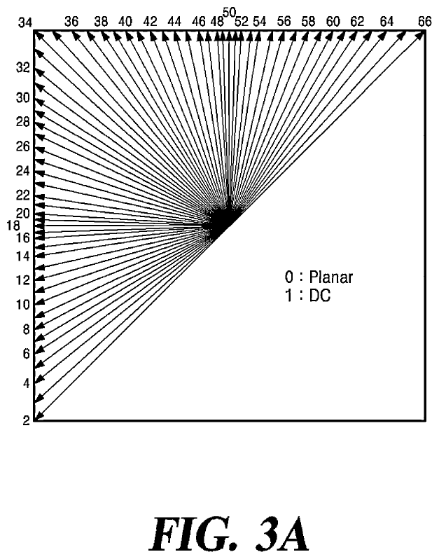

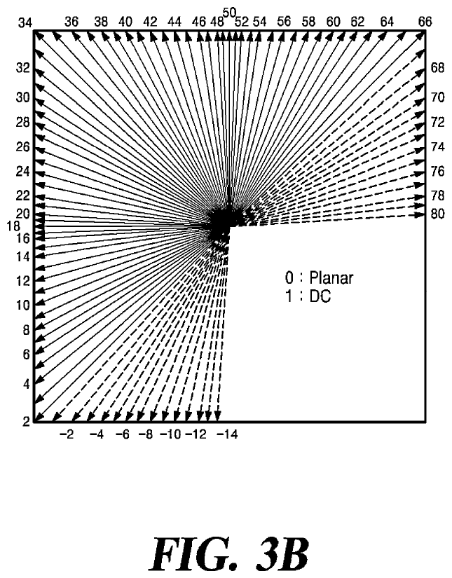

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current bock in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

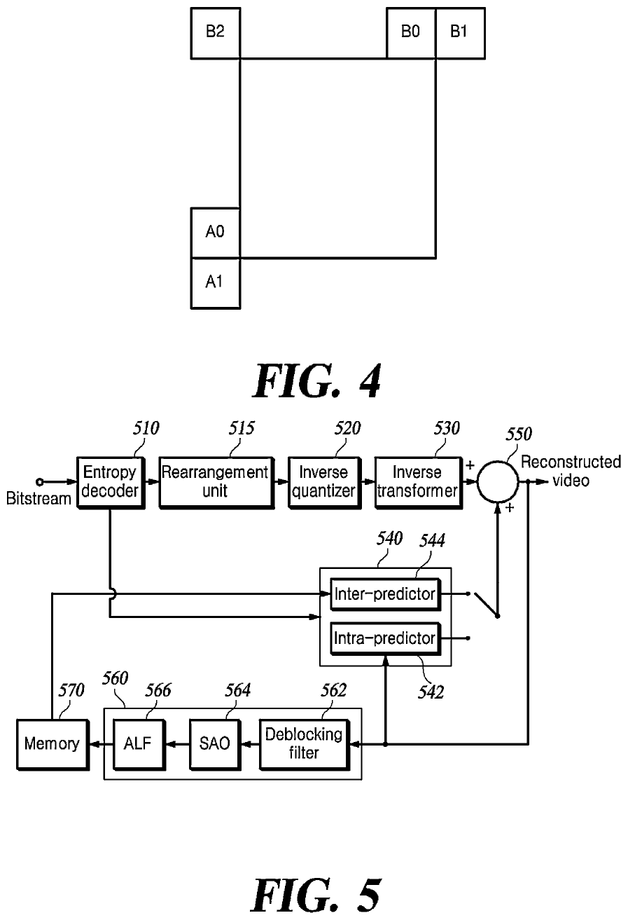

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus using an improved combined inter-prediction mode of advanced motion vector prediction mode and merge mode (AMVP-MERGE mode). The video coding method and the apparatus determine the merge index in the improved AMVP-MERGE mode in terms of rate-distortion optimization (RDO) in place of template matching or bi-directional matching.

The following embodiments may be performed by the inter predictor 124 in the video encoding device. The following embodiments may also be performed by the inter predictor 544 in the video decoding device.

The video encoding device when encoding the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with decoding the current block.

In the following description, the term “target block” may be used interchangeably with the current block or coding unit (CU). The term “target block” may refer to some region of the coding unit.

Further, the value of one flag being true indicates when the flag is set to 1. Additionally, the value of one flag being false indicates when the flag is set to 0.

### I-1. Merge/Skip Mode, MMVD, AMVP Mode, and AMVR

The merge/skip modes include regular merge mode, merge mode with motion vector difference (MMVD) mode, combined inter and intra prediction (CIIP) mode, geometric partitioning mode (GPM), and subblock merge mode. Here, the subblock merge mode is classified into subblock-based temporal motion vector prediction (SbTMVP) and affine merge mode.

Meanwhile, the advanced motion vector prediction mode (AMVP mode) includes a regular AMVP mode, a symmetric MVD mode, and an affine AMVP mode.

The following describes a method of composing a merging candidate list of motion information in regular merge/skip mode. To support the merge/skip mode, the inter predictor 124 in the video encoding device may select a preset number of (e.g., 6) merge candidates to compose the merging candidate list.

The inter predictor 124 searches for spatial merge candidates. The inter predictor 124 searches for spatial merge candidates from neighboring blocks as illustrated in FIG. 4. At most four spatial merge candidates may be selected. The spatial merge candidates are also referred to as a Spatial MVP (SMVP).

The inter predictor 124 searches for a temporal merge candidate. The inter predictor 124 may add, as a temporal merge candidate, a block that is co-located with the current block in a reference picture (which may be the same as or different from the reference picture used to predict the current block) other than the current picture that holds the target current block. One temporal merging candidate may be selected. A temporal merge candidate is also referred to as a Temporal MVP (TMVP).

The inter predictor 124 searches for history-based motion vector predictor (HMVP) candidates. The inter predictor 124 may store in a table the motion vectors of the previous h (where h is a natural number) CUs, and then may use the stored motion vectors as merge candidates. The table has a size of 6 and stores the motion vectors of the previous CUs in a first-in-first-out (FIFO) fashion. This indicates that up to six HMVP candidates are stored in the table. The inter predictor 124 may set the most recent motion vectors among the HMVP candidates stored in the table, as merge candidates.

The inter predictor 124 searches for Pairwise Average MVP (PAMVP) candidates. The inter predictor 124 may set the average of the motion vectors of the first candidate and the second candidate in the merging candidate list, as the merge candidate.

If the merging candidate list cannot be fulfilled (i.e., the preset number of candidates is not filled) after performing all of the above-mentioned search processes, the inter predictor 124 adds a zero motion vector as the merge candidate.

In terms of optimizing coding efficiency, the inter predictor 124 may determine a merge index that indicates one candidate in the merging candidate list. The inter predictor 124 may use the merge index to derive a motion vector predictor (MVP) from the merging candidate list and then may determine the MVP as the motion vector of the current block. Further, the video encoding device may signal the merge index to the video decoding device.

The video encoding device, in the skip mode, utilizes the same method of transmitting the motion vector as in the merge mode but does not transmit a residual block corresponding to the difference between the current block and the prediction block.

The above-described method of composing the merging candidate list may be performed equally by the inter predictor 544 in the video decoding device. The video decoding device may decode the merge index. The inter predictor 544 may use the merge index to derive the MVP from the merging candidate list and then may determine the MVP as the motion vector of the current block.

On the other hand, when the MMVD (Merge mode with Motion Vector Difference) technique is utilized, the inter predictor 124 may use the merge index to derive the MVP from the merging candidate list. For example, the first or second candidate in the merging candidate list may be utilized as the MVP. Further, in terms of optimizing coding efficiency, the inter predictor 124 determines a distance index and a direction index. The inter predictor 124 may use the distance index and the direction index to derive a motion vector difference (MVD) and then may sum the MVD and the MVP to reconstruct the motion vector of the current block. Further, the video encoding device may signal the merge index, the distance index, and the direction index to the video decoding device.

The MMVD technique described above may be equally performed by the inter predictor 544 in the video decoding device. The video decoding device may decode the merge index, the distance index, and the direction index. After composing the merging candidate list, the inter predictor 544 may use the merge index to derive an MVP from the merging candidate list. The inter predictor 544 may derive the MVD by using the distance index and the direction index and then may sum the MVD and the MVP to reconstruct the motion vector of the current block.

Hereinafter, a method of composing a candidate list of motion information in the AMVP mode of inter prediction is described. To support the AMVP mode, the inter predictor 124 in the video encoding device may select a preset number of (e.g., 2) candidates to form the candidate list.

The inter predictor 124 searches for spatial candidates. The inter predictor 124 searches for the spatial candidates from neighboring blocks as illustrated in FIG. 4. At most two spatial candidates may be selected.

The inter predictor 124 searches for a temporal candidate. The video encoding device may add, as a temporal candidate, a block that is co-located with the current block within a reference picture (which may be the same as or different from the reference picture used to predict the current block) other than the current picture holding the target current block. One temporal candidate may be selected.

If the candidate list cannot be fulfilled, i.e., the preset number of candidates is not met after performing all of the aforementioned searches, the inter predict 124 adds a zero motion vector as a candidate.

In terms of optimizing coding efficiency, the inter predict 124 may determine a candidate index that indicates one candidate in the candidate list. The inter predictor 124 may use the candidate index to derive an MVP from the candidate list. Further, in terms of optimizing coding efficiency, the inter predictor 124 determines the motion vector and then subtracts the MVP from the motion vector to calculate the MVD. The video encoding device may signal the candidate index and MVD to the video decoding device.

The method of composing the AMVP candidate list described above may be equally performed by the inter predictor 544 in the video decoding device. The video decoding device may decode the candidate index and MVD. The inter predictor 544 may use the candidate index to derive the MVP from the candidate list. The inter predict 544 may sum the MVD and MVP to reconstruct the motion vector of the current block.

Along with the MVD, the video encoding device transmits information that determines the spatial resolution of the MVD. When the AMVR (adaptive motion vector resolution) technique is used, the video encoding device may determine an adaptive spatial resolution of the MVD in terms of optimizing rate distortion. In this case, the spatial resolution of the MVD may be the same as that of the motion vector.

When the AMVR technique is used, the video encoding device signals amvr_flag and amvr_precision_idx to the video decoding device to indicate the spatial resolution of the MVD. Namely, when amvr_flag is signaled as 0, the video decoding device sets the MVD to a ¼-pel spatial resolution. On the other hand, when amvr_flag is not zero, the video decoding device may determine the spatial resolution of the MVD according to amvr_precision_idx. In this case, the selectable spatial resolution of the MVD may vary based on the prediction method that is subject to the AMVR. The prediction methods that the AMVR can be applied to are the regular AMVP mode, the affine AMVP mode, an IBC AMVP mode, and the like.

### I-2. Template Matching and Bilateral Matching

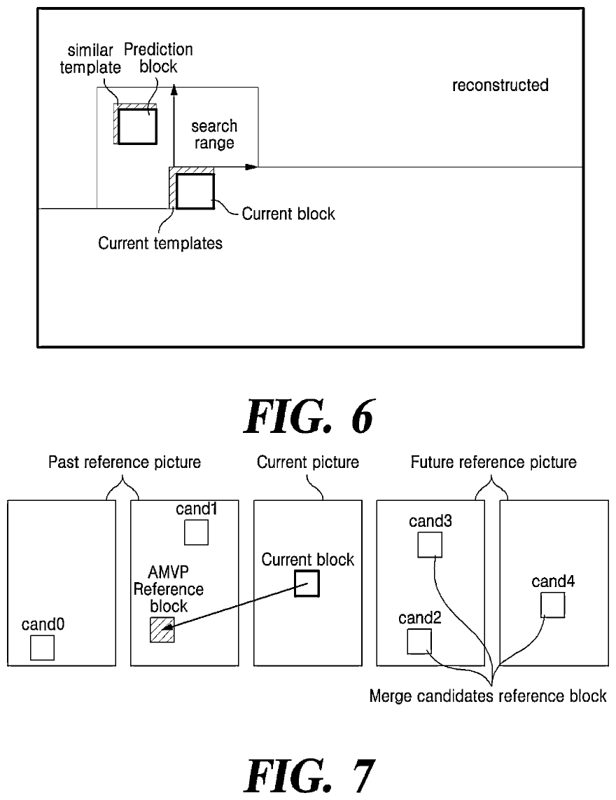

FIG. 6 is a diagram illustrating template matching.

In Template Matching (TM) mode, the intra-predictor 122 in the video encoding device uses a template in the reconstructed region of the current frame to search for an optimal reference block and uses the optimal reference block as a prediction block, as illustrated in FIG. 6. By calculating how closely the template matches the current templates, the intra predictor 122 may search for the most similar template to the current templates and may use the block corresponding to that similar template as the prediction block. The search range of the template may be preset, and the prediction of the current block may be performed based on the preset search range.

In one example, the technique of adaptive reordering of merge candidates (ARMC) with template matching adaptively reorders the merge candidates of the inter prediction based on the template matching described above. The reordering manner of merge candidates may be applied to the regular merge mode, a template matching merge mode, or the affine merge mode (except for the SbTMVP candidates).

For example, in the regular merge mode, the inter predictor 124 in the video encoding device may compose a merging candidate list and then may rearrange the merge candidates in ascending order according to the template matching cost (hereinafter, TM cost), i.e., in order of increasing cost. The TM cost may be defined as the sum of absolute differences (SAD) or the sum of squared errors (SSE) between the template samples in the current block and the corresponding reference samples.

In Bilateral Matching (BM) mode, the BM cost is calculated, which is the distortion between the two candidate blocks of the reference lists L0 and L1 in the reference pictures. The BM cost may be the SAD or SSE between the two candidate blocks. For example, if BM is applied to the merge mode in the AMVP-MERGE mode, the BM cost is calculated with respect to the AMVP prediction block and the MERGE prediction block.

Hereinafter, embodiments of the present disclosure are described regarding the video encoding device, but embodiments of the present disclosure may be similarly applicable to the video decoding device.

### II. Improved AMVP-MERGE Mode

### <Example 1> Efficient Merge Index Determination in AMVP-MERGE Mode

This example provides a method of efficiently determining a merge index in the AMVP-MERGE mode.

In the AMVP-MERGE mode according to this embodiment, the video encoding device selects an AMVP prediction block according to the method of the conventional AMVP-MERGE mode and transmits information on the reference index and the motion vector difference (MVD) of the corresponding AMVP mode to the video decoding device in the same conventional way. Further, the video encoding device transmits the MVP index information to the video decoding device or derives the MVP index information in the same way as in the conventional AMVP-MERGE mode. Namely, the video encoding device transmits the MVP index to the video decoding device when template matching is not used, and the video encoding device derives the MVP index when template matching is used.

This embodiment provides a method of determining a prediction block in the MERGE mode in the AMVP-MERGE mode.

In this embodiment, the video encoding device determines the prediction block in the MERGE mode based on rate-distortion optimization (RDO) instead of determining the prediction block based on template matching or bilateral matching. Instead of determining the index of the MERGE mode based on the cost of the prediction block in the AMVP mode and the corresponding prediction block in the MERGE mode, the video encoding device determines the index of the MERGE mode based on the cost for rate-distortion optimization of the current block also referred to as a coding unit (CU) and the prediction block in the AMVP-MERGE mode. Here, the prediction block in the AMVP-MERGE mode is generated by combining the prediction block in the AMVP mode and the corresponding prediction block in the MERGE mode. The prediction block in the AMVP mode may be generated based on the candidate list of the AMVP mode, and the prediction block in the MERGE mode may be generated based on the merging candidate list. Then, the video encoding device transmits the index information of the determined MERGE mode to the video decoding device.

In accordance with this embodiment, the prediction block in the AMVP-MERGE mode is determined based on the t rate distortion from the current block instead of simply determining the prediction block based on the cost of the AMVP mode and the MERGE mode, so that an accurate MERGE mode can be determined. Further, the complexity of the video decoding device may be reduced by transmitting/parsing the index information of the selected MERGE mode.

### <Example 2> Generating a Merging Candidate List for the AMVP-MERGE Mode

This example provides a method of generating a candidate list for the MERGE mode used in Example 1.

FIG. 7 is a diagram illustrating a block selected in the AMVP mode and merge candidates in a merging candidate list.

As illustrated in FIG. 7, the current picture, past reference picture, and future reference picture represent the current picture of interest, a previously encoded past picture, and a future picture to be encoded, respectively. The current block is present as the name represents and the AMVP reference block represents the prediction block that is selected and predicted in the AMVP mode corresponsive to the current block. cand0 through cand4 represent the merge candidates in the merging candidate list. In the example of FIG. 7, the number of merge candidates is five but is not necessarily limited to five. For example, N (where N is a natural number) merge candidates may be used.

In the AMVP-MERGE mode according to Example 1, the video encoding device transmits merge index information for the prediction block in the MERGE mode, which requires efficient ordering of the merging candidate list. As shown in the example of FIG. 7, in the AMVP-MERGE mode, the merge candidate blocks in the MERGE mode are limited to blocks in the direction opposite to the prediction blocks in the AMVP mode. In the example of FIG. 7, the merging candidate blocks in the MERGE mode in the AMVP-MERGE mode are cand2, cand3, and cand4. If the existing merging candidate list is used to transmit the merge index information in AMVP-MERGE mode, a waste of encoding bits may occur. Therefore, the video encoding device composes a merging candidate list for the AMVP-MERGE mode by using the modes available for use as merging candidate modes in the AMVP-MERGE mode.

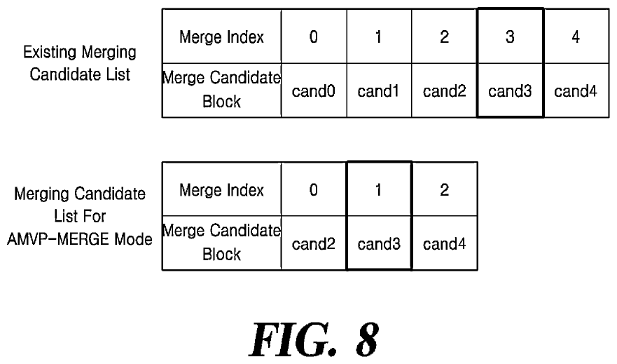

FIG. 8 is a diagram illustrating an existing merging candidate list and a merging candidate list for the AMVP-MERGE mode.

For the merging candidate list for the AMVP-MERGE mode in the example of FIG. 8, the video encoding device excludes cand0 and cand1, which are merge candidates in the same direction as the AMVP mode, from the merging candidate list. So, the video encoding device uses the merge candidates that exist in the opposite direction of the AMVP mode to compose the merging candidate list. When the merging candidate mode selected in the current AMVP-MERGE mode is cand3, and the existing merging candidate list is used, the information of the merge index 3 is transmitted. Since the merge index is encoded by using a truncated rice code, transmitting the merge index 3 needs 4 bits (1110 or 0001). However, when the merging candidate list is used for the improved AMVP-MERGE mode according to this embodiment, the information of merge index 1 is transmitted. Since the merge index is encoded by using truncated rice code, transmitting the merge index 1 needs 2 bits (10 or 01). Accordingly, the number of bits required for transmission/parsing of the merging candidate index may be reduced. Saving the bits required for transmission of the merge index, this embodiment can improve coding efficiency.

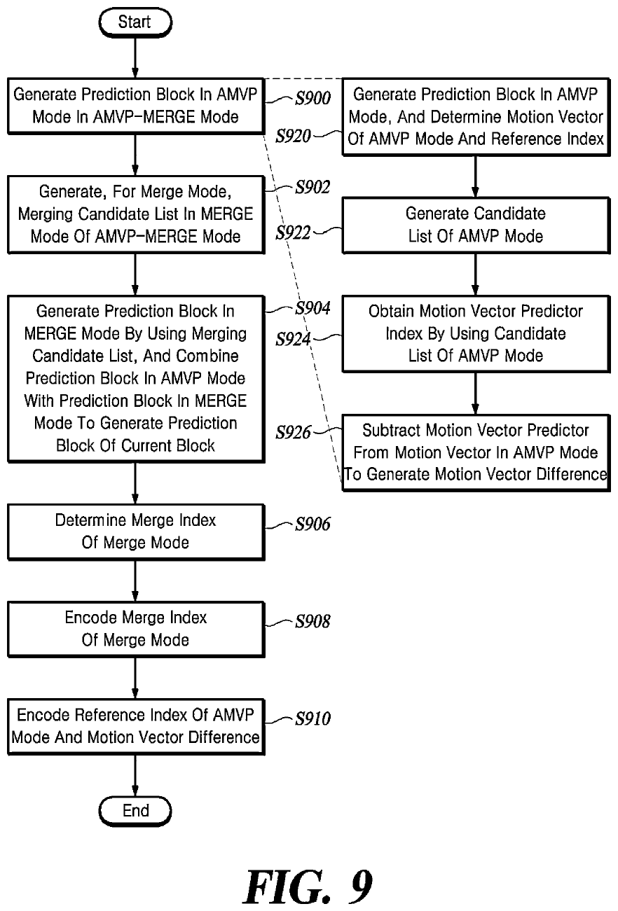

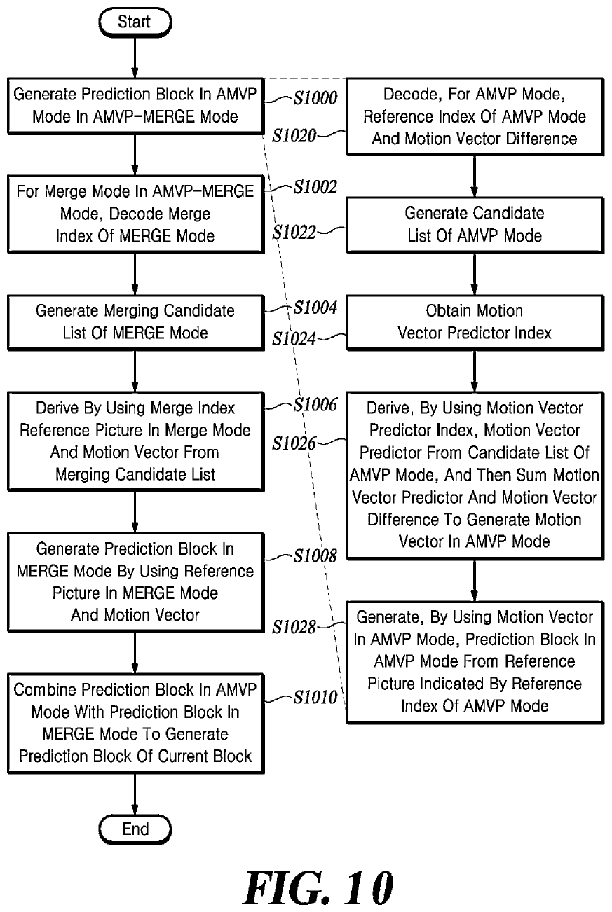

Referring now to FIGS. 9 and 10, a method of generating a prediction block of a current block according to an improved AMVP-MERGE mode is described.

FIG. 9 is a flowchart of a method performed by the video encoding device for generating a prediction block according to an improved AMVP-MERGE mode, in at least one embodiment of the present disclosure.

In AMVP-MERGE mode, the video encoding device generates a prediction block in an AMVP mode (S900).

The video encoding device may generate the prediction block in the AMVP mode by using the following steps.

The video encoding device generates the prediction block in the AMVP mode corresponding to the current block and determines a motion vector in the AMVP mode and a reference index (S920).

Here, the motion vector in the AMVP mode is a uni-directional vector that indicates the prediction block in the AMVP mode within the reference picture indicated by the reference index. In terms of optimizing rate distortion, the video encoding device may determine the motion vector in the AMVP mode and the reference index and may generate the prediction block in the AMVP mode.

The video encoding device generates a candidate list of the AMVP mode (S922). The video encoding device may generate the candidate list according to a conventional AMVP mode method as described above.

The video encoding device obtains a motion vector predictor index by using the candidate list of the AMVP mode (S924).

If template matching is not used, the video encoding device may select from the candidate list a candidate with the smallest difference from the predictor in the AMVP mode and then may set the index indicating the selected candidate as the motion vector predictor index. Thereafter, the video encoding device encodes the motion vector predictor index. On the other hand, when template matching is used, the video encoding device may select from the candidate list a candidate having a template with the smallest difference from the template of the predictor in the AMVP mode and then may derive the index indicative of the selected candidate as the motion vector predictor index.

The video encoding device subtracts the motion vector predictor from the motion vector in the AMVP mode to generate the motion vector difference (S926).

After generating the AMVP mode predictor, the video encoding device performs the following steps.

For the MERGE mode in AMVP-MERGE mode, the video encoding device generates a merging candidate list of the MERGE mode (S902). The video encoding device may compose the merging candidate list by using merge candidates that exist in a direction opposite to the direction indicated by the reference index of the AMVP mode.

The video encoding device generates a prediction block in the MERGE mode by using the merging candidate list and combines the prediction block in the AMVP mode and the prediction block in the MERGE mode to generate a prediction block of the current block (S904).

The video encoding device determines a merge index of the MERGE mode (S906).

Here, the merge index indicates a merge candidate. The merge candidate includes a reference picture and a motion vector utilized to generate the prediction block in the MERGE mode, and the prediction block in the MERGE mode resides within the reference picture in the MERGE mode. The video encoding device may determine a merge index based on a cost for rate-distortion optimization corresponding to the current block and the prediction block of the current block.

The video encoding device may encode the merge index of the MERGE mode (S908).

The video encoding device encodes the reference index of the AMVP mode and motion vector difference (S910).

FIG. 10 is a flowchart of a method performed by the video decoding device for generating a prediction block according to the improved AMVP-MERGE mode, in at least one embodiment of the present disclosure.

The video decoding device generates a prediction block in the AMVP mode in the AMVP-MERGE mode (S1000).

The video decoding device may generate the AMVP mode prediction block by using the following steps.

The video decoding device is corresponsive to AMVP mode for decoding from the bitstream the reference index of the AMVP mode and the motion vector difference (S1020).

The video decoding device generates a candidate list of the AMVP mode (S1022). The video decoding device obtains a motion vector predictor index (S1024).

If template matching is not used, the video decoding device decodes the motion vector predictor index from the bitstream. If template matching is used, the video decoding device may select from the candidate list a candidate having a template with the smallest difference from the template of the predictor in the AMVP mode and then may derive the index indicative of the selected candidate as the motion vector predictor index.

The video decoding device derives a motion vector predictor from the candidate list of the AMVP mode by using the motion vector predictor index and then sums the motion vector predictor and the motion vector difference to generate a motion vector in the AMVP mode (S1026). Here, the motion vector in the AMVP mode is a uni-directional vector.

The video decoding device uses the motion vector in the AMVP mode to generate a prediction block in the AMVP mode from the reference picture indicated by the reference index of the AMVP mode (S1028).

After generating the predictor in the AMVP mode, the video decoding device performs the following steps.

For the MERGE mode in the AMVP-MERGE mode, the video decoding device decodes from the bitstream the merge index of the MERGE mode (S1002).

Here, the merge index is determined by the video encoding device based on a cost for rate-distortion optimization for the current block and the prediction block of the current block, and then the determined merge index is transmitted to the video decoding device.

The video decoding device generates a merging candidate list of the MERGE mode (S1004). The video decoding device may compose the merging candidate list by using merge candidates that exist in a direction opposite to the direction indicated by the reference index of the AMVP mode.

The video decoding device derives a reference picture in the MERGE mode and a motion vector from the merging candidate list by using the merge index (S1006). The video decoding device sets the reference picture and motion vector of the candidate indicated by the merge index to be the reference picture in the MERGE mode and the motion vector.

The video decoding device generates a prediction block in the MERGE mode by using the reference picture in the MERGE mode and the motion vector (S1008).

The video decoding device combines the prediction block in the AMVP mode with the prediction block in the MERGE mode to generate a prediction block of the current block (S1010).

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

124: inter predictor
155: entropy encoder
510: entropy decoder
544: inter predictor

What is claimed is:

1. A method performed by a video decoding device for generating a prediction block of a current block, the method comprising:
generating a prediction block in an advanced motion vector prediction mode (AMVP mode) in an AMVP-MERGE mode;
decoding, for a merge mode in the AMVP-MERGE mode, a merge index of the merge mode from a bitstream;
generating a merging candidate list of the merge mode;
deriving, by using the merge index, a reference picture in the merge mode and a motion vector from the merging candidate list;
generating a prediction block in the merge mode by using the reference picture in the merge mode and the motion vector; and
combining the prediction block in the AMVP mode with the prediction block in the merge mode to generate a prediction block of the current block.

2. The method of claim 1, wherein generating the prediction block in the AMVP mode includes:
decoding, for the AMVP mode, a reference index and a motion vector difference of the AMVP mode from the bitstream;
generating a candidate list of the AMVP mode;
obtaining a motion vector predictor index;
deriving, by using the motion vector predictor index, a motion vector predictor from the candidate list of the AMVP mode;
generating a motion vector in the AMVP mode by summing the motion vector predictor and the motion vector difference; and
using the motion vector in the AMVP mode to generate the prediction block in the AMVP mode from a reference picture indicated by the reference index of the AMVP mode.

3. The method of claim 2, wherein obtaining the motion vector predictor index includes:
decoding the motion vector predictor index from the bitstream when a template matching is not used; and
deriving the motion vector predictor index when a template matching is used.

4. The method of claim 2, wherein generating the merging candidate list includes:
composing the merging candidate list by using merge candidates that exist in a direction opposite to a direction indicated by the reference index of the AMVP mode.

5. The method of claim 1, further comprising:
determining the merge index by a video encoding device based on a cost for rate-distortion optimization on the current block and the prediction block of the current block.

6. A method of decoding a motion vector of a current block by a video decoding device, the method comprising:
generating a prediction block in an advanced motion vector prediction mode (AMVP mode) in an AMVP-MERGE mode;
generating, for a merge mode in the AMVP-MERGE mode, a merging candidate list of the merge mode;
generating a prediction block in the merge mode by using the merging candidate list;
combining the prediction block in the AMVP mode with the prediction block in the merge mode to generate a prediction block of the current block; and
determining a merge index of the merge mode.

7. The method of claim 6, wherein generating the prediction block in the AMVP mode includes:
generating the prediction block in the AMVP mode for the current block;
determining a motion vector and a reference index of the AMVP mode;
generating a candidate list of the AMVP mode;
obtaining a motion vector predictor index by using the candidate list of the AMVP mode; and
generating a motion vector difference by subtracting a motion vector predictor from the motion vector in the AMVP mode.

8. The method of claim 7, wherein obtaining the motion vector predictor index includes:
determining the motion vector predictor index when a template matching is not used; and
deriving the motion vector predictor index when a template matching is used.

9. The method of claim 7, wherein generating the merging candidate list includes:
composing the merging candidate list by using merge candidates that exist in a direction opposite to a direction indicated by the reference index of the AMVP mode.

10. The method of claim 6, wherein the merge index is determined based on a cost for rate-distortion optimization on the current block and the prediction block of the current block.

11. The method of claim 6, further comprising:
encoding the merge index of the merge mode.

12. The method of claim 7, further comprising:
encoding the reference index of the AMVP mode and the motion vector difference.

13. A computer-readable recording medium storing a bitstream generated by a video encoding method, the video encoding method comprising:
generating a prediction block in an advanced motion vector prediction mode (AMVP mode) in an AMVP-MERGE mode;
generating, for a merge mode in the AMVP-MERGE mode, a merging candidate list of the merge mode;
generating a prediction block in the merge mode by using the merging candidate list;
combining the prediction block in the AMVP mode with the prediction block in the merge mode to generate a prediction block of a current block; and
determining a merge index of the merge mode.
